(19) United States
(12) Patent Application Publication
(10) Pub. No.: US 2005/0058963 A1
(43) Pub. Date: Mar. 17, 2005

(54) Combination interproximal dental stripper

(76) Inventor: John W. Stockstill, Evans, GA (US)

Correspondence Address: JAGTIANI + GUTTAG, 10363-A DEMOCRACY LANE, FAIRFAX, VA, 22030, US

(21) Appl. No.: 10/664,039

(22) Filed: Sep. 17, 2003

(51) Int. Cl. A61C 3/06

(52) U.S. Cl. 433/166

(57) ABSTRACT

Interproximal reduction (IPR) is accomplished with use of a combination stripper having two distinct ends. The first end has a single abrasive side and the second distinct end is abrasive on both sides.

### BACKGROUND OF THE INVENTION

1. Field of the Invention

The present invention relates generally to interproximal reduction (IPR) in dentistry, and more particularly to an interproximal dental stripper providing both a single-sided abrasive as well as a double-sided abrasive portion.

2. Description of the Prior Art

In the discipline of orthodontics, it is often necessary to reduce tooth structure interproximally to correct for inadequate space caused by dental crowding and in restorative dentistry to trim or contour various types of restorative materials such as amalgam or composite resin. Single-sided and double-sided abrasive strips are widely used in modern dentistry. The strips currently available do not have one- and two-sided regions on a single strip. The efficiency and effectiveness of the metal strip increases when abrasive is added to the other (reverse) side of the metal strip. When a double-sided strip is used, adequate space must exist between the teeth in question in order to allow for the added thickness of the strip to comfortably fit. If the teeth are in tight contact, minimal space must be initially created, using a single-sided strip, so that the thicker double-sided strip may be used. Initial use of a double-sided strip between tightly crowded teeth may lead to unacceptable patient discomfort and trauma of teeth already subject to orthodontic treatment. Thus a double-sided strip may not be substituted exclusively for a single-sided strip.

### SUMMARY OF THE INVENTION

A combination strip would provide several advantages over prior products. The two regions on the strip allow the clinician to avoid having to first remove a single-sided strip and insert a second double-sided strip. The use of one strip to properly create adequate space reduces time spent stripping individual teeth by approximately 50%. Furthermore, single-sided and double-sided strips are currently advertised as being sterilizable for repeat use. However, due to the nature of microscopic entrapment of debris within the grit, the practice of using sterilized, recycled strips among different patients is objectionable. A combination strip would provide a more cost effective, hygienic alternative to conventional strips.

It is therefore an object of the present invention to provide an interproximal stripper that provides a single-sided strip distally joined and integral to a double-sided strip.

It is a further object to provide a combination interproximal stripper strip that provides a more hygienic and cost effective method of interproximal reduction.

According to a first broad aspect of the present invention, there is provided a interproximal strip comprising at least three zones arranged in longitudinal succession wherein a middle zone is a central smooth zone flanked by a first integral abrasive specialty zone and a second integral abrasive specialty zone.

According to a second broad aspect of the invention, there is provided a method of interproximal reduction whereby an interproximal strip is inserted between two adjacent teeth at a central smooth zone wherein said central smooth zone of said interproximal strip is flanked by a first integral abrasive specialty zone and a second integral abrasive specialty zone to create space between said adjacent teeth by abrading said teeth with said first integral abrasive specialty zone with a first degree of abrasiveness and to increase said space by abrading said teeth with said second integral abrasive specialty zone with a second degree of abrasiveness on a front side and a third degree of abrasiveness on a rear side of said second integral specialty zone.

Other objects and features of the present invention will be apparent from the following detailed description of the preferred embodiment.

### BRIEF DESCRIPTION OF THE DRAWINGS

The invention will be described in conjunction with the accompanying drawings, in which:

FIG. 1A is a front view of an interproximal stripper constructed in accordance with an embodiment of the present invention; and

FIG. 1B is a rear view of the interproximal stripper of FIG. 1A.

### DETAILED DESCRIPTION OF THE PREFERRED EMBODIMENT

It is advantageous to define several terms before describing the invention. It should be appreciated that the following definitions are used throughout this application. Definitions

Where the definition of terms departs from the commonly used meaning of the term, applicant intends to utilize the definitions provided below, unless specifically indicated.

For the purposes of the present invention, the term “abrasive” refers to a substance used for grinding, sanding or polishing enamel, dentin, amalgam, or any composite hybrid restorative material.

For the purposes of the present invention, the term “distally attached” refers to portions of a strip aligned without abutment.

For the purposes of the present invention, the term “double-sided” refers to a quality existing on two sides of a strip portion.

For the purposes of the present invention, the term “integral” refers to the characteristic of two portions being attached to each other in a manner to inhibit separation, such as by adhesive, molding, etc.

For the purposes of the present invention, the term “single-sided” refers to a quality existing on one side of a strip portion.

For the purposes of the present invention, the term “specialty zone” refers to a portion of a strip having distinct qualities, such as length, abrasiveness, etc.

### DESCRIPTION

Interproximal reduction (IPR) is a dental procedure by which tooth structure or tooth restorative material is mechanically removed from the lateral surfaces of a tooth or teeth. In orthodontics, it is often necessary to reduce tooth structure interproximally in order to correct for inadequate space caused by dental crowding. This type of procedure, IPR, is routinely carried out when teeth are significantly crowded due to a lack of sufficient space for the teeth in their respective arches. It is also employed in restorative dentistry to trim or contour various types of restorative materials such as amalgam or composite resin. Additionally, this procedure allows for proper positioning of significantly malposed teeth before, during and after comprehensive orthodontic treatment. Most often, the reduction is carried out manually using abrasive strips that fit in between the teeth (interproximally) and enable conservative reduction of tooth structure and subsequent creation of space.

The majority of orthodontic cases involve dental crowding, and IPR is routinely used in combination with acceptable orthodontic treatment to resolve these crowding problems. A strip is initially wedged between crowded adjacent teeth along a portion of the strip that is smooth. Tooth reduction is achieved by moving the strip in a forward/backward or facial/lingual direction until adequate space is created. Single-sided strips allow for interproximal reduction of only one tooth at a time. This type of reduction requires an operator to adequately reduce tooth structure on a single tooth, and then remove the strip and reverse sides so that an adjacent tooth may be reduced.

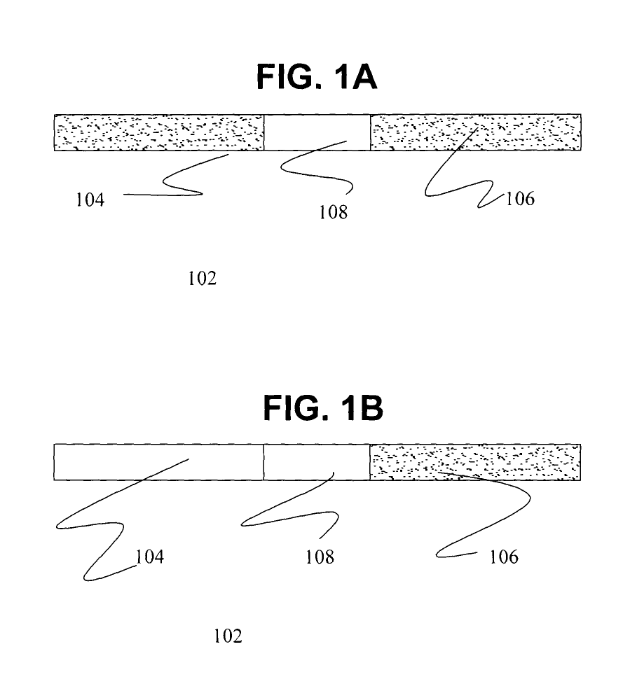

A combination interproximal strip in accordance with the present invention allows fine tooth reduction of a single tooth and then a smoother transition to bilateral reduction. FIGS. 1A and 1B illustrate a combination interproximal strip according to the present invention. Combination strip 102 has two distinct distal ends. Strip 102 has a smooth central zone 108 flanked on either side by specialty zones 104 and 106. Specialty zone 104 is a single-sided abrasive portion. Specialty zone 106 is a double-sided abrasive portion wherein the abrasives on either side of specialty zone 106 may be identical degrees of abrasiveness or two different degrees of abrasiveness. Specialty zones 104 and 106 may be substantially equal in length or may be different in length. For example, in a 145 mm combination strip, the smooth central zone 108 may be approximately 15 mm in length to allow for interproximal placement between crowded teeth. However, it should be understood that the combination strip may be 140 to 160 mm in length with specialty zones of 60 to 70 mm in length on the strip and the strip may be 7 to 10 mm wide. The combination strip of the present invention may be manufactured from a suitable material for a sterile environment while maintaining flexibility for maneuverability within a patient's mouth. Suitable materials for manufacture of a strip of the present invention include polyester, aluminum, aluminum alloy, etc. Any suitable coating, such as diamond coating having industrial coating or diamond particles, with an average grain diameter in the range of approximately 8 to 150 μm, may provide the abrasiveness of the specialty zones.

Successful IPR results from use of smooth zone 108 to interproximally introduce the strip between crowded teeth, primary creation of space using the single-sided specialty zone 104, and secondary bilateral reduction with double-sided specialty zone 106. A combination strip of the present invention allows use of a single strip to create adequate interproximal space and may reduce time spent stripping teeth by approximately 50%. Additionally, since a single strip is used for both primary and secondary tooth reduction, cost is also reduced.

The combination strips of the present invention may be a one-piece construction or formed of parts. Furthermore, the combination strips may be sterilizable through conventional methods. The strips of the present invention may be sold individually or sold as kits offering multiple strips of various abrasive degrees.

All documents, patents, journal articles and other materials cited in the present application are hereby incorporated by reference.

Although the present invention has been fully described in conjunction with the preferred embodiment thereof with reference to the accompanying drawings, it is to be understood that various changes and modifications may be apparent to those skilled in the art. Such changes and modifications are to be understood as included within the scope of the present invention as defined by the appended claims, unless they depart therefrom.

1. An interproximal strip comprising:
at least three zones arranged in longitudinal succession wherein a middle zone is a central smooth zone flanked by a first integral abrasive specialty zone and a second integral abrasive specialty zone.

2. The interproximal strip of claim 1, wherein said first integral abrasive specialty zone has a first degree of abrasiveness on a single side.

3. The interproximal strip of claim 2, wherein said second integral abrasive specialty zone has a second degree of abrasiveness on a front side of said strip and a third degree of abrasiveness on a rear side of said strip.

4. The interproximal strip of claim 3, wherein said first degree of abrasiveness is approximately equal to said second degree of abrasiveness.

5. The interproximal strip of claim 3, wherein said first degree of abrasiveness is different than said second degree of abrasiveness.

6. The interproximal strip of claim 4, wherein said second degree of abrasiveness is approximately equal to said third degree of abrasiveness.

7. The interproximal strip of claim 4, wherein said second degree of abrasiveness is different than said third degree of abrasiveness.

8. The interproximal strip of claim 5, wherein said second degree of abrasiveness is approximately equal to said third degree of abrasiveness.

9. The interproximal strip of claim 5, wherein said second degree of abrasiveness is different than said third degree of abrasiveness.

10. A method of interproximal reduction comprising:
inserting an interproximal strip between two adjacent teeth at a central smooth zone of said interproximal strip wherein said central smooth zone is flanked by a first integral abrasive specialty zone and a second integral abrasive specialty zone;
creating space between said adjacent teeth by abrading said teeth with said first integral abrasive specialty zone with a first degree of abrasiveness; and
increasing said space by abrading said teeth with said second integral abrasive specialty zone with a second degree of abrasiveness on a front side and a third degree of abrasiveness on a rear side of said second integral specialty zone.

11. The method of interproximal reduction of claim 10, wherein said first degree of abrasiveness is approximately equal to said second degree of abrasiveness.

12. The method of interproximal reduction of claim 10, wherein said first degree of abrasiveness is different than said second degree of abrasiveness.

13. The method of interproximal reduction of claim 11, wherein said second degree of abrasiveness is approximately equal to said third degree of abrasiveness.

14. The method of interproximal reduction of claim 11, wherein said second degree of abrasiveness is different than said third degree of abrasiveness.

15. The method of interproximal reduction of claim 12, wherein said second degree of abrasiveness is approximately equal to said third degree of abrasiveness.

16. The method of interproximal reduction of claim 13, wherein said second degree of abrasiveness is different than said third degree of abrasiveness.
